(19) United States
(12) Patent Application Publication
(10) Pub. No.: US 2002/0052867 A1
(43) Pub. Date: May 2, 2002

(54) Screen display method and recording medium for recording screen display character string

(75) Inventors: Kotaro Shimizu, Hachioji-shi (JP); Masaya Katsumata, Sagamihara-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 09/952,100

(22) Filed: Sep. 14, 2001

(30) Foreign Application Priority Data
Sep. 18, 2000 (JP) 2000-282706

(51) Int. Cl. G06F 7/00

(52) U.S. Cl. 707/1

(57) ABSTRACT

A screen display method of displaying a display character string defined by a character string file on a screen, comprises assigning a title character string that is a word and sentence indicating contents of the display character string to the display character string in the character string file, retrieving the character string to be displayed using the display character string assigned to the character string in the character string file, and displaying the display character string corresponding to the retrieved title character string on the screen.

### CROSS-REFERENCE TO RELATED APPLICATIONS

This application is based upon and claims the benefit of priority from the prior Japanese Patent Application No. 2000-282706, filed Sep. 18, 2000, the entire contents of which are incorporated herein by reference.

### BACKGROUND OF THE INVENTION

1. Field of the Invention

The present invention relates to a screen display of a computer program, more specifically, relates to a screen display method of all the computer programs necessary to adapt to a plurality of languages and a recording medium for recording screen display character strings.

2. Description of the Related Art

In recent years, the striking internationalization of business has been developed to increase the need of adaptation of computer programs developed, for example, in English-speaking countries to be displayed in English for English speakers to Japanese users living in Japan, i.e., so-called “Japanization”. In contrast, computer programs developed in Japan and exported to the other countries also need to be modified to change display to English from Japanese.

There have been thus proposed techniques of adapting a computer program to a plurality of languages, for example, the technique disclosed in Japanese Patent No. 3028996.

As shown in FIG. 1, this technique comprises a processing program 11 for executing a predetermined task, a display defining file 12 for displaying the processing result by the processing program 11, a screen display character string file 13 for classifying the contents of the displayed character string in unit of a predetermined contents and controlling the classified units by the character string numbers denoting the character strings respectively, and a screen display 14. The display defining file 12 controls screen numbers each corresponding to a screen to be displayed, the character string numbers, and a displayed position at which a character string number on a screen corresponding to a screen number, such that they correspond to each other. The contents of the character string corresponding to the character string number in the screen display character string file 13 is displayed in accordance with the screen number of the screen to be displayed, at the display position in the screen 14 controlled by the display defining file 12.

With such a constitution, each of the character string to be displayed is controlled by denoting the specific character string number in unit of the contents in the screen display character string file 13. More specifically, the English character string “COMPANY CODE” to be displayed is denoted by the character number “001”, and the character string “COMPANY NAME” is denoted by “002”.

According to such a method wherein each character string to be displayed is controlled by denoting the specific character string number in unit of the contents, however, it cannot be intuitively recognized what screen contents the character string number “001” or “002” denotes.

Because of this, when the screen display character rile 13 is prepared by an editor or the like, or when the character string needs to be displayed in the other language, it needs to be checked what screen contents the character string numbers “001”, “002”, . . . denote, one by one, which is terribly troublesome.

### BRIEF SUMMARY OF TEE INVENTION

The present invention is thus intended to provide a screen display method capable of easily performing jobs such as preparing, editing and the like of a screen display character string file, and of adapting a computer program to a plurality of languages, and a recording medium having recorded screen display character string files therein.

A screen display method of displaying a display character string defined by a character string file on a screen according to the present invention is characterized by comprising: assigning a title character string that is a word and sentence indicating contents of the display character string to the display character string in the character string file; retrieving the character string to be displayed using the display character string assigned to the character string in the character string file; and displaying the display character string corresponding to the retrieved title character string on the screen. With above configuration, the following manners are preferable.

(1) The character string file is stored in a storing section.

(2) The character string file is prepared in a text format.

(3) The character string file contains a plurality of character string files having languages different from each other, and one of the character string files is selected in accordance with a language to be used.

(4) Steps of preparing a screen display information file defining information necessary for displaying, and displaying the display character string retrieved from the character string file in accordance with the information in the screen display information file are further provided.

The recoding medium according to the present invention is a computer readable recording medium which records a screen display character string capable of being read by a computer, and is characterized by comprising; a character string file containing a display character string to be displayed and a title character string that is assigned to the character string to correspond thereto and is a word and sentence indicating contents of the display character string.

The recording medium according to the present invention stores a screen display character string to be displayed on a screen and a title character string that is a word or sentence indicating contents of the display character string so as to correspond to each other. In displaying the display character string, the display character string to be displayed is retrieved using the title character string by the processing program, and the retrieved display character string is displayed on the screen. With this method, the processing program needs not to be changed even in changing the character string to be displayed on the screen into another language. The displayed language can be switched merely by changing the display character string stored in the character string file.

Further, the display character string retrieved by the title character string can be displayed on the screen in accordance with the information defined in the screen display information file. With this method, the processing program needs not to be changed even in changing the displaying manner of the character string on the screen. The displaying manner of the display character string can be changed merely by changing the display character string stored in the screen display information file.

Further, the character string file contains the title character string indicating the contents of the display character string together with the display character string, and thus the contents can be easily guessed, which makes the switching to another language easy.

In addition, the display character string is retrieved using the title character string, and thus the display character strings in the character string file 1 can be written in an arbitrary order. Further, the initial character of the title character string of the display character file may be denoted by a special character (“#”, for example) to specify that row as an annotation row. In this manner, a character string file capable to be used for various purposes can be prepared.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a figure showing a conventional screen display method and character string file;

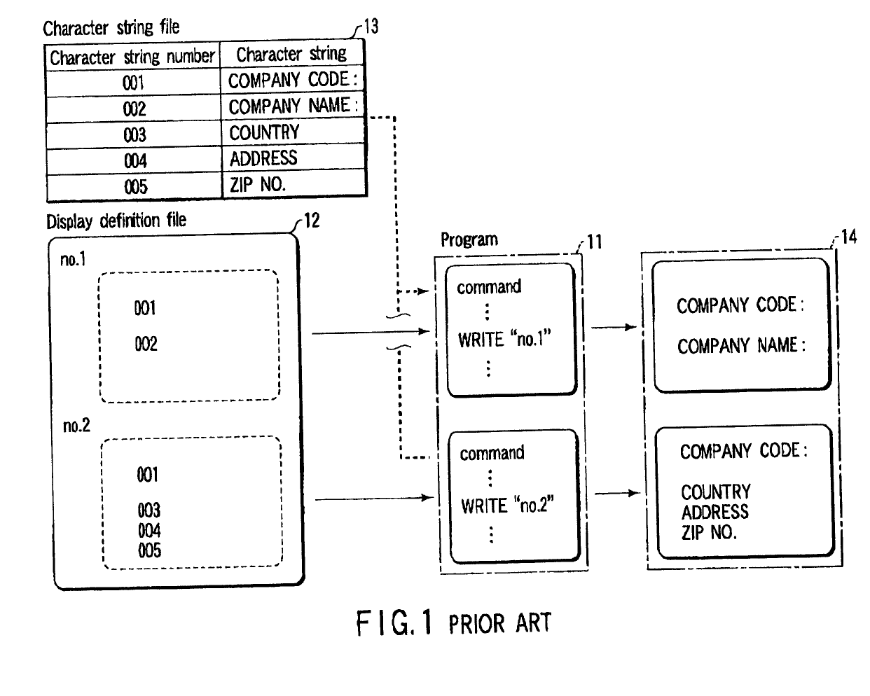

FIG. 2 is a figure showing the schematic constitution of a program system to which a screen display method according to an embodiment of the present invention is applied;

FIG. 3 is a flow chart showing the flow of the process of a screen display processing program used to the embodiment;

FIG. 4 is a figure showing a character string file and a screen display result when the character string file is displayed in Japanese in the embodiment; and

FIG. 5 is a figure showing a modification of the present invention.

### DETAILED DESCRIPTION OF THE INVENTION

An embodiment of the invention will be explained with reference to the accompanying drawings.

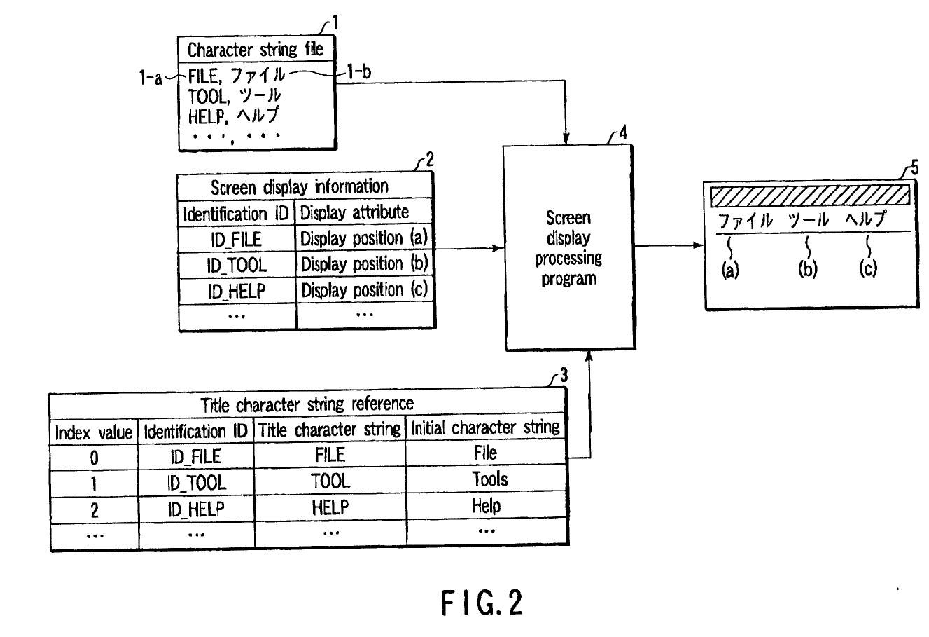

FIG. 2 shows a schematic constitution of a program system to which a screen display method according to the present invention is applied.

In FIG. 2, a character string file 1 is a file stored in an external storage device and a recording medium such as HD and FD in a computer capable of being read by a computer, and comprises a text file in a CSV format, for example, which can be edited by an editor or the like. The character string file 1 includes a first column title character string 1-a and a second column title character string 1-b. The second column -title character string 1-b is the character string actually displayed on a screen 5. The first column title character string 1-a is the character string comprising a word or a sentence as a keyword indicating the contents displayed by the second column title character string 1-b. This embodiment will be described assuming that an English word that is a language spoken widely around the world is used as the first column title character string 1-a and the second column title character string 1-b is displayed in English. For example, the second column title character string 1-b File, is assigned to the first column title character string 1-a “FILE”, the second column title character string 1-b “Tools” is assigned to the first column title character string 1-a “TOOL”, and the second column title character string 1-b “Help” is assigned to the first column title character string 1-a “HELP”.

Screen display information 2 is information referred when a screen 5 is displayed by a screen display processing program 4 to be described later. In this case, a display of the display character string may be executed by reading the instruction thereof or all the processings is may be executed in the screen display processing program 4. The screen display information 2 is stored in a memory (not shown) in a computer. The screen display information 2 is information defining information necessary in displaying the character string on the screen 5, and comprises display attribute information 2-b (a displayed position, a font name, a font size, and the like) and display character string identification ID 2-a for identifying on a computer program the character string displayed on the screen 5 in accordance with the display attribute information 2-b. According to the present embodiment, an identification ID 2-a “ID-FILE” is assigned to the character string to be displayed at a position (a) on the screen 5, an identification ID 2-a “ID_TOOL” is assigned to the character string to be displayed at a position (b) on the screen 5, and an identification ID 2-a “ID_HELP” is assigned to the character string to be displayed at a position (c) on the screen 5.

A title character string reference table 3 is a table stored in a memory in a computer. The title character string reference table 3 has an index value 3-a as one of serial numbers corresponding thereto, a display character string identification ID 3-b, a title character string 3-c, and an initial display character string 3-d. The initial display character string 3-d is an initial value of the character string to be displayed, and used when a processing program 4 (described later) cannot attain the display character string 1-b corresponding to the title character string 1-a in the character string file 1. In the present embodiment, when the index value is 0, the display character string identification ID 3-b is defined as “ID_FILE”, the title character string 3-c is defined as “FILE”, and the initial display character string 3-d is defined as “File”, respectively. When the index value is 1, the display character string identification ID 3-b is defined as “ID_TOOL”, the title character string 3-c is defined as “TOOL”, and the initial display character string 3-d is defined as “Tools”, respectively. When the index value is 2, the display character string identification ID 3-b is defined as “ID_HELP”, the title character string 3-c is defined as “HELP”, and the initial display character string 3-d is defined as “Help”, respectively.

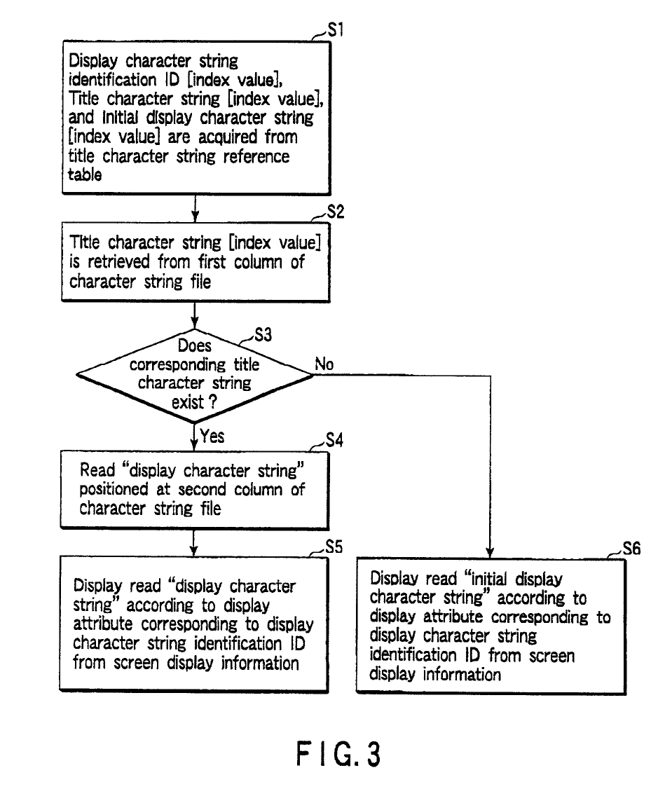

With use of the character string file 1, the screen display information 2, and the title character string reference table 3, the screen display processing program 4 for displaying the screen 5 of the computer is executed by a CPU, as shown in FIG. 3.

In step S1 at first, the title character string reference table 3 is referred by the index value 3-a to acquire the display character string identification ID 3-b, the title character string 3-c, and the initial display character string 3-d. Assuming that the index value is 0, “ID_FILE” as the display character string identification ID 3-b, “FILE” as the title character string 3-c, and “File” as the initial display character string 3-d are acquired, respectively.

Next, in step S2, the retrieval is executed to determine whether or not the title character string 3-c acquired from the title character string table 3-c is present in the first column of title character string 1-a in the character string file 1. In this time, for example, it is determined whether or not the title character string “FILE” acquired from the title character string table is present in the first column of title character string 1-a in the character string file 1.

When the desired title character string is present in the first column of title character string 1-a (step S3) in the character string file 1, the processing proceeds to step S4 to read the second column of display character string 1-b corresponding to the first column of title character string 1-a. In the present embodiment, the title character string “FILE” is present in the first column of title character string 1-a in the character string file 1, the display character string “File” is read from the corresponding second column of display character string 1-b.

In step S5, a predetermined display character string is displayed on the screen 5 based on the display character string identification ID 3-b acquired in the step S1 and the display character string 1-b read in the step S4. In this case, a predetermined display character string is displayed on the screen 5 in accordance with the display attribute 2-b corresponding to the display character string identification ID 2-a in the screen display information 2. In the present embodiment, the display character string “File” read in the step S5 is displayed on the screen 5 in accordance with the display attribute corresponding to the display character string identification ID “ID_FILE” acquired in the step S1.

On the other hand, when the desired title character string is not present in the first column of title character string i-a in the character string file 1 in the step S3, the processing proceeds to step S6 and a predetermined display character string is displayed on the screen 5 based on the display character string identification ID 3-b acquired in the step S1 and the initial display character string 3-d as parameters. For example, when the desired title character string “FILE” is not present in the first column of title character string 1-a in the character string file 1, the initial display character string “File” acquired in the step S1 is displayed on the screen 5 in accordance with the display attribute corresponding to the display character string identification ID “ID_FILE” acquired in the step S1.

By executing the series of the steps as mentioned above for the index values 1 and 2 similarly, the display character strings “Tools” and “Help” are displayed on the screen 5 in the same manner.

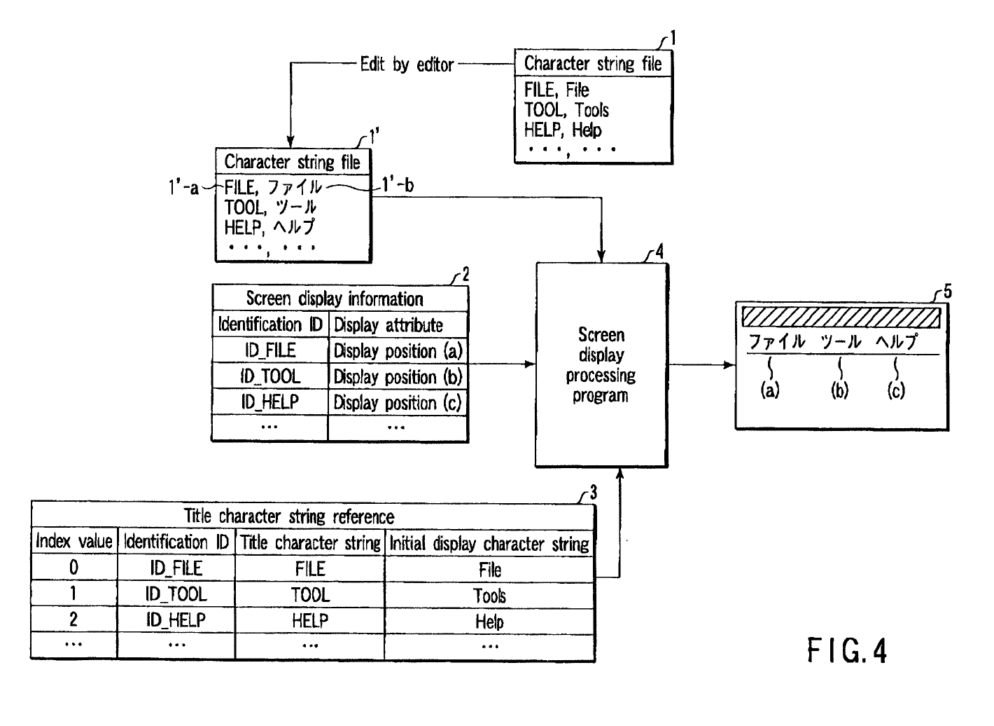

On the other hand, in the case where the displayed language is switched from English to another language, for example, Japanese, the character string file 1 for English display described in FIG. 2 is edited by the editor to prepare another character string file 11 for Japanese display as shown in FIG. 4. In this case, this character string file 1′ also includes the first column of title character string 1′-a and the second column of title character string 1′-b. The first column title character string 1′-a is displayed in English. To the first column of title character string 1′-a “FILE”, the second column of title character string 1′-b “ [symbol] ” is assigned, to the first column of title character string 1′-a “TOOL”, the second column of title character string 1′-b “ [symbol] ” is assigned, and to the first column of title character string 1′-a “HELP”, the second column of title character string 1′-b “ [symbol] ” is assigned.

After processing in this manner, the screen display processing program 4 is executed to display the display character string “ [symbol] ” corresponding to the title character string “FILE”, the display character string “ [symbol] ” corresponding to the title character string “TOOL”, and the display character string “ [symbol] ” corresponding to the title character string “HELP” on the screen 5, respectively, as shown in FIG. 4. In this manner, the displayed language can be switched to Japanese.

In this case, when the character string file for another language such as the character string file 1′ for Japanese display as employed in the present embodiment is used to switch the screen display to the display for the other language by editing with use of the editor, the title character string 1′-a in the character string file 1′ is denoted by a specific word, i.e., the English word such as “FILE”, “TOOL”, or “HELP”. With such a method, it is very easy to make a display character string 1′-b to be displayed on the screen and another title character string 1′-a to correspond each other when the display character string 1′-b to be actually displayed is written in the character string file 1′. More specifically, according to the conventional method, the screen display character strings are controlled by the character string numbers such as “001” and “002”, and thus it cannot be intuitively recognized what screen contents the character string number “001” or “002” denotes. In order to recognize the contents of the character string, the correspondence thereof needs to be checked, one by one In contrast, according to the present invention wherein the title character string is denoted by the specific word (English in the present embodiment) such as “FILE”, “TOOL”, or “HELP”, it is very easy to guess the title character string, which will eliminate so troublesome checking the correspondence between the title character string and the contents. As a result, the job such as preparing, editing and the like of the screen display character string will be so simplified thereby.

In the present embodiment, the screen display information 2 and the title character string reference table 3 are stored in a memory in a computer, but need not to be limited thereto and may be stored as a file in an external storage and a recording medium such as FD and HD and read by the screen display processing program 4. Similarly, the screen display information 2 and the title character string reference table 3 need not to be stored independently, but may be formed in a table constituted by the index value, the title character string, the initial display character string, and the display attribute (the displayed position, the font name, and the font size).

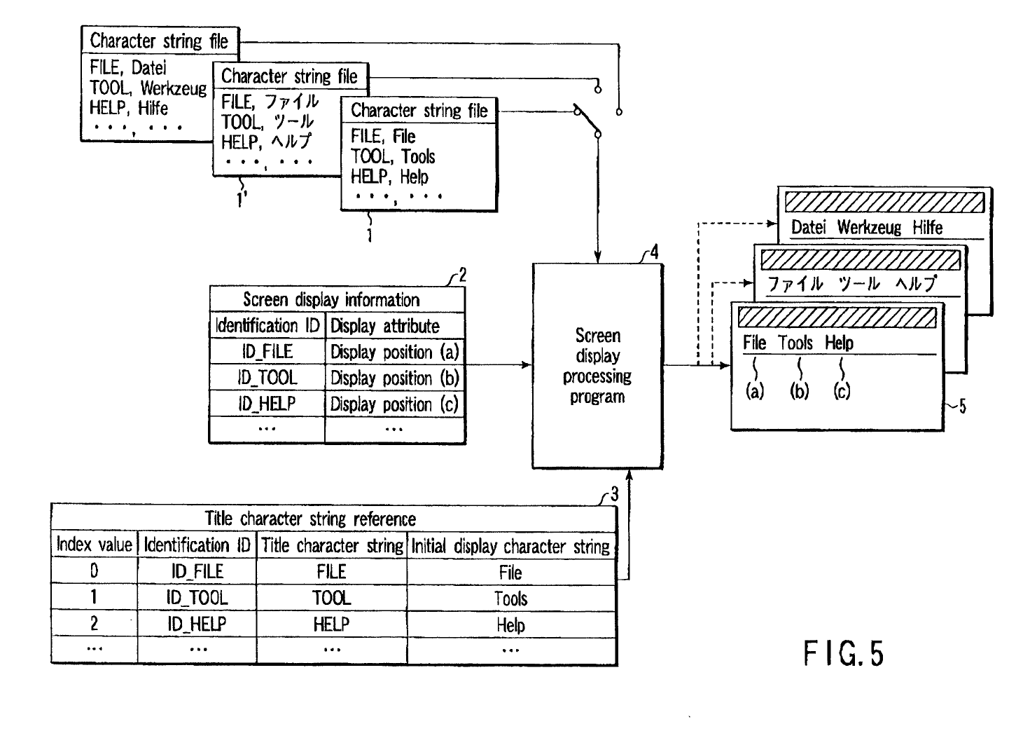

Further, when the displayed language is switched from English to Japanese, the character string file 1 for English is edited using the editor to be replaced with the character string file 1′ for Japanese in the present embodiment, but the present invention is not limited thereto. For example, the character string file to be referred by the screen display processing program 4 may be selected from the character string file 1 for English or the character string file 1′ for Japanese in accordance with the language to be displayed, as show in FIG. 5.

Similarly, the language to be displayed is not limited to English and Japanese, and the character string file of another language such as German may be employed, as show in FIG. 5.

Further, in the present invention, the character string file corresponds to the title character string and the display character string, but the present invention is not limited thereto, and the initial character of the title character string may be denoted by a special character (“#”, for example) to specify that row as an annotation row. By specifying in this manner, the display character string can be arbitrarily classified.

In the same manner, the present embodiment prepares a character string file for each of the languages, but a character string file may be prepared for a plurality of languages. In this case, a number of the languages are written in a header, for example, and the character string file may be constituted to have the contents as presented below:

“a title character string, a character string 1, a character string file 2”, that is,

“FILE, Datai (German), [symbol] (Japanese), . . . ”. In this case, it is given as the initial value of the program which character string file should be displayed in accordance with the displayed language.

As described above, according to the present invention, the title character string is denoted by the specific word or sentence, it is very easy-to guess the title character string, which will eliminate so troublesome checking the correspondence between the title character string and the contents in preparing the display character string to be displayed on the screen in the character string file. As a result, the job such as preparing, editing and the like of the screen display character string will be so simplified thereby.

Further, since the retrieval of the display character string can be performed merely by retrieving the title character string, the retrieval can be attained merely by making the display character string and the title character string to correspond each other, and thus does not depend on the stored position thereof. Therefore, the maintenance will be performed with ease.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A screen display method of displaying a display character string defined by a character string file on a screen, comprising:
assigning a title character string that is a word and sentence indicating contents of the display character string to the display character string in the character string file;
retrieving the character string to be displayed using the title character string assigned to the display character string in the character string file; and
displaying the display character string corresponding to the retrieved title character string on the screen.

2. A screen display method according to claim 1, wherein the character string file is stored in a storing section.

3. A screen display method according to claim 1, wherein the character string file is prepared in a text format.

4. A screen display method according to claim 1, wherein
the character string file contains a plurality of character string files having languages different from each other, and
one of the character string files is selected in accordance with a language to be used.

5. A screen display method according to claim 1, further comprising:
preparing a screen display information file defining information necessary for displaying, and
displaying the display character string retrieved from the character string file in accordance with the information in the screen display information file.

6. A computer readable recording medium which records a screen display character string capable of being read by a computer, comprising:
a character string file containing a display character string to be displayed and a title character string that is assigned to the display character string to correspond thereto and is a word and sentence indicating contents of the display character string.
